(19) United States
(12) Patent Application Publication
(10) Pub. No.: US 2024/0001722 A1
(43) Pub. Date: Jan. 4, 2024

(54) APPARATUS FOR MOUNTING TIRES IN BICYCLES, MOTORCYCLES AND THE LIKE

(71) Applicant: OFF ROAD S.R.L., Valsamoggia (IT)

(72) Inventor: Alessandro CERASI, Mo (IT)

(21) Appl. No.: 18/250,472

(22) PCT Filed: Oct. 27, 2021
(86) PCT No.: PCT/EP2021/079766

§ 371 Date: Apr. 25, 2023

(30) Foreign Application Priority Data
Oct. 27, 2020 (IT) 202020000006001

(51) Int. Cl. B60C 25/05

(52) U.S. Cl. CPC B60C 25/0503; B60C 25/0566

(57) ABSTRACT

An apparatus for mounting tires in bicycles, motorcycles, includes at least one main frame and at least one support provided with a seat whose shape and dimensions are complementary to those of the hub of a rim of a wheel of a vehicle for temporary accommodation thereof. The support is integral with the main frame. The apparatus includes at least one pair of jaws that are integral with the main frame; at least one element for the mutual clamping of the jaws;
and at least one portion of the lateral surface of the tire is interposed between the ends of the jaws subjected to clamping. In this configuration, the portion is compressed transversely to facilitate the arrangement of the bead of the tire within a respective receptacle of the rim, which is rotatably coupled with respect to the seat and therefore also with respect to the jaws.

### CROSS-REFERENCE TO RELATED APPLICATIONS

This application is a 35 U.S.C. § 371 National Stage patent application of PCT/EP2021/079766, filed on 27 Oct. 2021, which claims the benefit of Italian patent application 202020000006001, filed on 27 Oct. 2020, the disclosures of which are incorporated herein by reference in their entirety.

### TECHNICAL FIELD

The present disclosure relates to an apparatus for mounting tires in bicycles, motorcycles and the like.

In particular, the apparatus according to the disclosure allows an easy mounting of tires (i.e., the part of the wheel of a vehicle that is provided with a tread designed to abut against the ground during use), particularly in bicycles, motorcycles and other vehicles that have similar requirements.

The reference vehicle type for the present disclosure is the one for which the use of filling inserts, to be inserted between the tire (tubeless or not) and the rim, is currently provided.

In particular, such inserts are constituted by expanded foams made of polymeric (generally elastomeric) material.

In practice, the inserts replace a traditional inner tube inside the tire, ensuring that an ideal support of the tire persists even upon damage that would induce a puncture.

By virtue of this technical solution it is therefore possible to avoid punctures and all the problems that derive from them.

### BACKGROUND

In the sports field, this need is particularly felt, and therefore tire filling inserts are used in off-road motorcycling (particularly in cross, enduro and the like), in off-road cycling (particularly in so-called downhill, in enduro and the like) and, in some other cases, also for particular vehicles designed to operate off-road.

The main problem that is observed is the great difficulty in inserting the so-called bead (i.e., the terminal and innermost part of the shoulder of the tire) in the lip of the respective rim, so as to ensure the stable positioning of the tire in said rim, when a filling insert is inserted in the tire.

The filling insert is in fact made of expanded material and must be compressed in order to be inserted in the tire.

Upon insertion, the shoulders of the tire are divaricated (i.e., arranged at a greater mutual distance) since the insert tends elastically to expand.

Placement of the shoulders within the lip of the rim is therefore very difficult, since it requires to compact the tire (moving the shoulders mutually closer) and fit the shoulders in the rim only after compaction.

The main problem is linked to the fact that this operation requires a lot of time for the designated operator. The only possibility to reduce mounting times is to have a team of operators work simultaneously, and their labor increases mounting costs enormously.

### SUMMARY

The aim of the present disclosure is to solve the problems described above, providing an apparatus for mounting tires in bicycles, motorcycles and the like that simplifies the operations for inserting the beads of a tire in the containment lips of the respective rim when the tire accommodates a filling insert.

Within this aim, the disclosure provides an apparatus for mounting tires in bicycles, motorcycles and the like that speeds up the operations for inserting the beads of a tire in the containment lips of the respective rim when the tire accommodates a filling insert.

the disclosure also provides an apparatus for mounting tires in bicycles, motorcycles and the like that allows a single operator to perform the operations for inserting the beads of a tire in the containment lips of the respective rim when the tire accommodates a filling insert.

the disclosure further provides an apparatus for mounting tires in bicycles, motorcycles and the like that minimizes labor costs related to the operations for inserting the beads of a tire in the containment lips of the respective rim when the tire accommodates a filling insert.

The present disclosure provides an apparatus for mounting tires in bicycles, motorcycles and the like that has low costs, is relatively simple to provide in practice and is of assured application.

This aim and these and other advantages that will become more apparent hereinafter are achieved by providing an apparatus for mounting tires in bicycles, motorcycles and the like, characterized in that it comprises
at least one main frame,
at least one support provided with a seat whose shape and dimensions are complementary to those of the hub of a rim of a wheel of the reference vehicle for the temporary accommodation thereof, said support being integral with said main frame,
at least one pair of mutually opposite jaws, each of which is provided with an end which can be arranged so as to face the vicinity of an edge of said rim of said wheel, said jaws being integral with said main frame,
at least one element for the mutual clamping of said jaws, at least one portion of the lateral surface of said tire to be mounted on said rim being interposed in the configuration for use between the ends of said jaws subjected to said clamping, in said configuration said portion being compressed transversely, in order to facilitate the arrangement of the so-called bead of said tire within a respective receptacle of said rim which is rotatably coupled with respect to said seat and therefore also with respect to said jaws.

### BRIEF DESCRIPTION OF THE DRAWINGS

Further characteristics and advantages of the disclosure will become better apparent from the description of a preferred but not exclusive embodiment of the apparatus for mounting tires in bicycles, motorcycles and the like, illustrated by way of non-limiting example in the accompanying drawings, wherein:

FIG. 1 is a schematic perspective view of a possible embodiment of an apparatus for mounting tires in bicycles, motorcycles and the like according to the disclosure during a mounting operation;

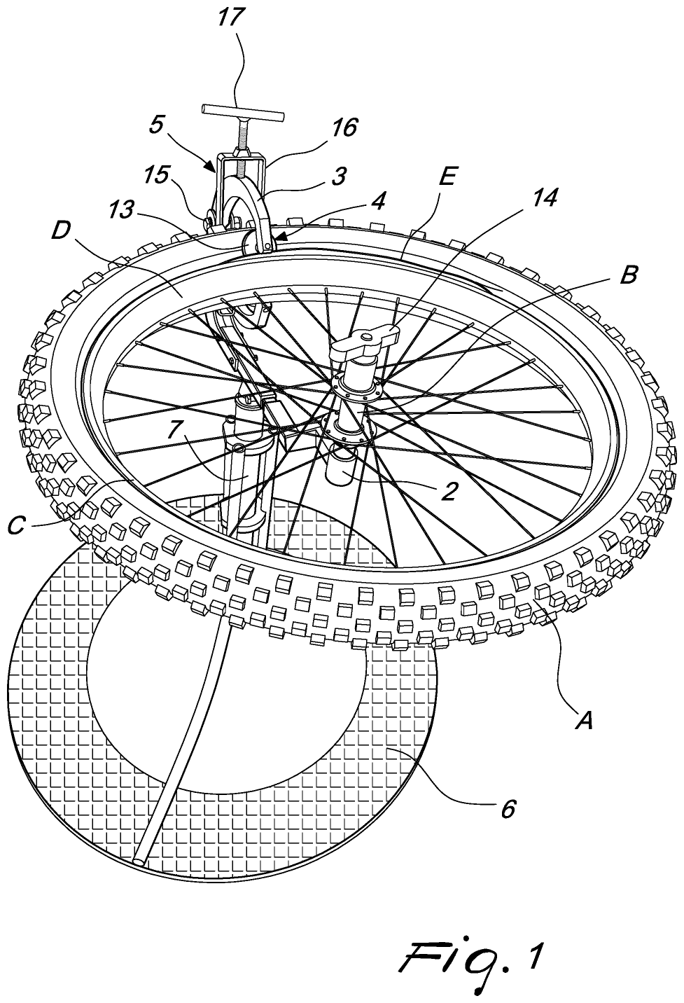

FIG. 2 is a schematic perspective view of the apparatus of FIG. 1; and

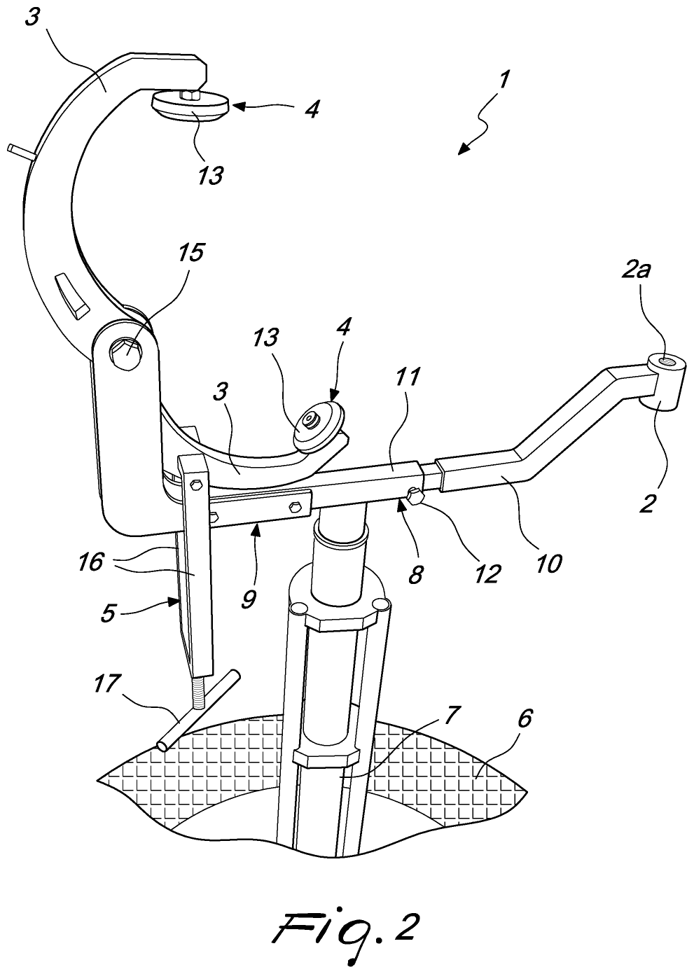

FIG. 3 is a schematic perspective view of the apparatus of FIG. 1 during a mounting operation.

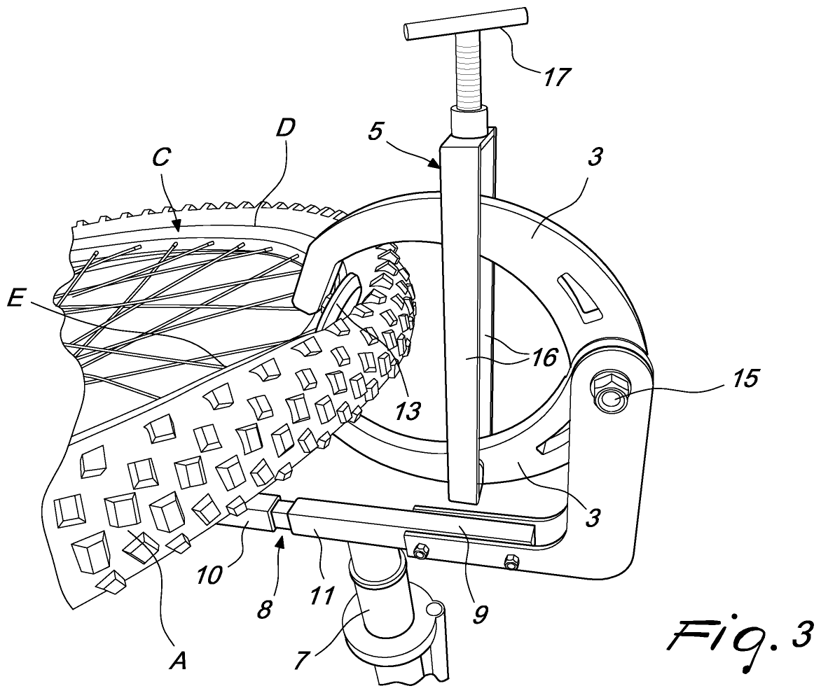

### DETAILED DESCRIPTION OF THE DRAWINGS

With particular reference to the figures, the reference numeral 1 generally designates an apparatus for mounting tires A in bicycles, motorcycles and the like.

The apparatus 1 according to the disclosure comprises at least one main frame to which all the additional components are coupled.

The apparatus is provided with at least one support 2 provided with a seat 2a the shape and dimensions of which are complementary to those of the hub B of a rim C of a wheel of the reference vehicle.

The seat 2a is suitable for the temporary (and at least partial) accommodation of the hub B.

The support 2 is integral with the main frame.

The apparatus 1 further comprises at least one pair of mutually opposite jaws 3. Each individual jaw 3 can advantageously be provided with an end 4 which can be arranged so as to face the vicinity of an edge D of the rim C of the wheel.

The jaws 3 also are integral with the main frame: it is not excluded that one of the jaws 3 might be of a removable type in order to facilitate the operations for the fitting of the rim C (with the tire A arranged thereon) on the apparatus 1.

The apparatus 1 according to the disclosure may further conveniently comprise at least one element 5 for the mutual clamping of the jaws 3.

In the configuration for use, at least one portion of the lateral surface of the tire A to be mounted on the rim C is favorably interposed between the ends 4 of the jaws 3 subjected to the clamping of the element 5.

In this configuration, such interposed portion is conveniently compressed transversely in order to facilitate the arrangement of the so-called bead E of the tire A within a respective receptacle of the rim C (receptacle delimited by the two edges D). Since the rim C is rotatably coupled to the apparatus 1 with respect to the seat 3, it is noted that once the configuration for clamping the tire A has been assumed, which is matched by the corresponding transverse compression between the ends 4 of the jaws 3, the rotation of the rim C produces a progressive movement of the ends 4 along the lateral surface of the tire A which allows to fit the bead E of the tire A within the edge D of the rim C.

The adoption of means for temporarily locking the rotation of the rim C with respect to the seat 2a, which are necessary in order to keep said rim C fixed during the mounting operations, is not excluded.

This operation is particularly complex if inside the tire A there is a puncture prevention insert (generally constituted by expanded or in any case elastically deformable material), which would tend to widen the tire A transversely, making it very difficult to insert the corresponding beads E in the receptacle of the rim C delimited between the corresponding edges D.

In this case, the clamping of the jaws 3, obtained by means of the respective element 5, allows the operator to be able to rely on an optimum transverse compression of the tire A, which facilitates the operations for inserting the bead E in the receptacle of the rim C delimited by the edges D.

With particular reference to a possible constructive solution of unquestionable interest in practice and in application, the main frame comprises a footing 6 and a post 7: the at least one support 2 and the at least one pair of jaws 3 are therefore coupled advantageously to respective top arms 8, 9 of the post 7.

It is specified that the adoption of posts 7 which allow variations of their length, for example by means of telescopic and/or sliding inserts, is provided. This mode of embodiment allows to adapt the height at which the rim C will be arranged to the specific requirements of the operator (in particular to his height and/or to the need to work while sitting or standing).

The footing 6 can be shaped so as to rest on the floor or on a worktable (optionally for coupling to bench vises and the like).

Furthermore, it is specified that at least one of the arms 8, 9 can conveniently be constituted by a prismatic pair of beams 10, 11 which can slide with respect to each other. In this case, a unit 12 for the mutual coupling of the beams 10, 11 according to a plurality of different mutual coupling configurations, which correspond to different total lengths of the at least one arm 8, 9, is provided.

For example, the variation of the length of the arm 8, by means of the mutual sliding of the beams 10, 11 (and the respective locking in any mutual configuration by means of the unit 12) is particularly useful, since it allows to adapt the apparatus 1 to different types of rims C (i.e., which correspond to different sizes and/or different models and/or designed for different vehicles), always allowing the correct alignment of the ends 4 of the jaws 3 with respect to the lateral surface of the tire A (for the clamping and transverse compression thereof).

One embodiment of unquestionable interest in practice and in application provides for the end 4 of at least one jaw 3 to advantageously comprise a wheel 13 that is designed, in the configuration for clamping the jaws 3 on the lateral surface of the tire A, to reduce the friction of the end 4 on said lateral surface by in fact rolling thereon.

It is specified that the wheels 13 might be variously shaped in order to ensure a compression action on the tire A that is particularly indicated for each specific application.

It is specified that as an alternative to the wheels 13 the ends 4 might equivalently comprise sliders made of self-lubricating material or other rolling elements (such as rollers, balls, barrels, cones and the like) so as to ensure in any case an easy sliding of the end 4 on the lateral surface of the tire when the jaws 3 compress it transversely.

During the rotation of the rim C with respect to the seat 2a, the ends 4 can therefore clamp the tire A, compressing it transversely, without braking the rotation excessively and helping to fit the bead E of the tire A within the edge D of said rim C.

In order to describe a possible validly operating embodiment, it is specified that the seat 2a whose shape and dimensions are complementary to those of the hub B of the rim C may advantageously comprise a threaded internal portion for the accommodation of a shaft provided with an end that is complementary to the end of the threaded internal portion, for the coupling of the rim C, ensuring a degree of freedom of rotation with respect to the longitudinal axis of the shaft. In practice, the rim C is pivoted to the seat 2a by means of the shaft, which can comprise (at the opposite end to the one that comprises the threaded portion) respective grip means in order to facilitate its clamping (for example a handle 14).

From a constructive standpoint, it is specified that the at least one element 5 for the mutual clamping of the jaws 3 comprises a tension member which is at least partially interposed between said jaws 3 at a predefined distance from the respective pivoting axis 15.

The tension member is favorably provided with at least one device for adjusting the length of its portion that is interposed between the jaws 3, with consequent variation of the opening of the jaws 3.

For example, the device for adjusting the length of the tension member may validly comprise a threaded coupling between a terminal portion of the tension member and a knob. The initial end of the tension member is instead integral with a first jaw 3.

The terminal portion of the tension member is accommodated slidingly in a through hole of the second jaw 3 and the screwing of the knob on at least one part of the terminal portion that protrudes with respect to the second jaw 3 produces a variation of the mutual distance of the jaws 3.

This solution may also provide for an external framework 16 which is pivoted to a jaw 3, can be arranged on the other one jaw and is shaped substantially like a carpenter's vise: in this case, a threaded presser 17 can be screwed or unscrewed with respect to a threaded hole of the framework 16 in order to modify the relative opening of the jaws 3.

It is evident that the embodiment that has just been described is equivalent to the one illustrated previously, in which the mutual clamping of the jaws 3 was obtained with a tension member (and in which a knob could be screwed onto the terminal of the tension member).

As an alternative, the adjustment device can conveniently comprise an eccentric rotatable lever which is coupled to the terminal end of the tension member.

In this case, the initial end of the tension member is integral with a first jaw 3, while the corresponding terminal end passes through a through hole of the second jaw 3.

The rotations of the lever modify the length of the portion of the tension member that is comprised between the jaws 3, modifying the respective opening thereof (and therefore the distance between the ends 4).

In a manner similar to what was shown earlier, this embodiment also may be provided equivalently by adopting an external framework 16 which is hinged to a jaw 3, can be arranged on the other jaw and is shaped substantially like a carpenter's vise: the eccentric rotatable lever, by rotating, modifies the relative opening of the jaws 3.

It is not excluded to adopt additional and different elements 5 for the mutual clamping of the jaws 3 among the possible technical solutions of the known type.

In general terms, it is specified that the jaws 3 might also be validly constituted by respective mutually opposite pushers: the terminal ends 4 of said jaws 3 would therefore be movable from a first arrangement of maximum mutual distance, at which there is between them a distance that is greater than the transverse thickness of the tire A, to a second arrangement of minimum mutual distance, at which there is between them a distance that is shorter than the transverse thickness of the tire A, with consequent transverse compression thereof and of its content, for easy insertion of the tire A within a respective receptacle of the rim C.

It is not excluded that the apparatus 1 according to the disclosure might conveniently comprise at least one actuator controlled by a component chosen between the at least one element for the controlled mutual clamping of the jaws 3 and the at least one rim C rotatably engaged in the seat 2a of the support 2.

The actuator can thus ensure optimum clamping of the jaws 3 (optionally providing programmable strokes for them), or can determine the rotation of the rim C when the jaws 3 are clamped in order to fit the bead E of the tire within the lip D of the rim C (this rotation may also be programmed according to a predefined angular stroke).

The possibility to install actuators in the post 7 (in order to actuate its height variations) or in the arms 8, 9 (in order to actuate their length variations) is not excluded.

Any actuators present may equally be of the electric, pneumatic, hydraulic type or combinations thereof, although in any case their control by an independent and external mechanical motor drive is not excluded.

In practice, the apparatus according to the disclosure allows, after performing the necessary format adjustments (for example by modifying the height of the post 7 and/or the total length of the arms 8 and 9), to arrange the rim C on the support 2, fixing the corresponding hub B to the seat 2a.

The rim C in this case is already partially coupled to the tire A (in which the puncture prevention insert will have been inserted beforehand) so that one of the beads E thereof is already completely arranged within a respective lip D of the rim C.

One then proceeds with the mutual clamping of the jaws 3, so that they compress the tire A transversely, moving (at the region where clamping occurs) both of the beads E of the tire A inside the lips D of the rim (and therefore in the respective receptacle).

By actuating the rotation of the rim C with respect to the seat 2a, the ends 4 slide on the side wall of the tire A (in particular, the wheels 13 rotate thereon), fitting the bead E inside the lip D up to complete insertion, which corresponds to the correct mounting of the tire A on the rim C.

It is specified that in some cases the operations for completion of the insertion of the bead E of the tire A in the receptacle of the rim C may require a direct intervention of the operator, who might have to insert, by means of manual levers, the last part of the bead E that is still external to the receptacle.

The apparatus 1 according to the disclosure can be used synergistically with clamps for clamping tires A such as those shown in EUIPO European union model no. 007732151 in the name of this same Applicant.

Advantageously, the present disclosure solves the drawbacks described earlier, providing an apparatus 1 for mounting tires A in bicycles, motorcycles and the like that simplifies the operations for inserting the beads E of a tire A in the containment lips D of the respective rim C when the tire A accommodates a filling insert (such as for example a puncture prevention insert).

Favorably, the apparatus 1 according to the disclosure ensures that all the forceful operations on the tire A in order to cause the bead E of the tire A to exit from the lip D of the rim C or the subsequent insertion of the bead E in the lip D are performed without the operator having to perform manual forcing (assigning the task of insertion exclusively to the apparatus 1) or using levers on the rim C or on the spokes thereof.

Efficiently, the apparatus 1 according to the disclosure can operate on any wheel diameter (since the arm 8 is constituted by the two beams 10 and 11, which can be extracted with respect to each other in order to adjust the overall length of the arm 8 and therefore the distance between the seat 2a and the jaws 3 according to a broad adjustment range) and tire size (since it is possible to adjust the mutual approach of the jaws 3 as a function of the dimensions of the tire A).

Positively, the apparatus 1 according to the disclosure speeds up the operations for inserting the beads E of a tire A in the containment lips D of the respective rim C, when the tire A accommodates a filling insert (such as for example a puncture prevention insert).

Usefully, the apparatus 1 according to the disclosure allows a single operator to perform the operations for inserting the beads E of a tire A in the containment lips D of the respective rim C, when the tire A accommodates a filling insert (such as for example a puncture prevention insert).

Conveniently, the apparatus 1 according to the disclosure minimizes the labor costs related to the operations for inserting the beads E of a tire A in the containment lips D of the respective rim C, when the tire A accommodates a filling insert (such as for example a puncture prevention insert).

Validly, the apparatus 1 according to the disclosure is relatively simple to provide in practice and has low costs: these characteristics render the described apparatus 1 an innovation of assured application.

The disclosure thus conceived is susceptible of numerous modifications and variations, all of which are within the scope of the appended claims; all the details may furthermore be replaced with other technically equivalent elements.

In particular it is specified that it is possible to integrate a retention claw on at least one component associated with the main frame of the apparatus 1 in order to act as a support for a lever (used to fit the bead E of the tire A within the lip D) as in devices for removing tires of cars, so as to avoid the execution of forcing actions on the lip D of the rim C.

In the embodiments shown, individual characteristics, given in relation to specific examples, may actually be interchanged with other different characteristics that exist in other embodiments.

In practice, the materials used, as well as the dimensions, may be any according to the requirements and the state of the art.

1-10. (canceled)

11. An apparatus for mounting tires comprising:
at least one main frame;
at least one support provided with a seat whose shape and dimensions are complementary to those of a hub of a rim of a wheel of a vehicle for temporary accommodation thereof, said support being integral with said main frame;
at least one pair of mutually opposite jaws, each of which is provided with an end which is configured to be arranged so as to face a vicinity of an edge of said rim of said wheel, said jaws being integral with said main frame; and
at least one element for mutual clamping of said jaws, at least one portion of a lateral surface of said tire to be mounted on said rim being interposed in a configuration for use between the ends of said mutually opposite jaws subjected to said clamping, in said configuration said portion being compressed transversely, in order to facilitate an arrangement of a bead of said tire within a respective receptacle of said rim which is rotatably coupled with respect to said seat and therefore also with respect to said jaws.

12. The apparatus according to claim 11, wherein said main frame comprises a footing and a post, said at least one support and said at least one pair of jaws being coupled to respective top arms of said post.

13. The apparatus according to claim 12, wherein at least one said arms is constituted by a prismatic pair of beams which can slide with respect to each other and comprises units for mutual coupling of said beams according to a plurality of different mutual coupling configurations which correspond to different overall lengths of said at least one arm.

14. The apparatus according to claim 11, wherein said end of at least one said jaw comprises a wheel which is designed, in a configuration for clamping said jaws on said lateral surface of said tire, to reduce friction of said end on said lateral surface, by rolling thereon.

15. The apparatus according to claim 11, wherein said seat whose shape and dimensions are complementary to those of the hub of said rim comprises a threaded internal portion for the accommodation of a shaft provided with an end which is complementary to an end of said threaded internal portion for retention of said rim, ensuring a degree of freedom of rotation with respect to a longitudinal axis of said shaft.

16. The apparatus according to claim 11, wherein said at least one element for the mutual clamping of said jaws comprises a tension member which is at least partially interposed between said jaws at a predefined distance from a respective pivoting axis, said tension member being provided with at least one device for an adjustment of a length of a portion thereof that is interposed between said jaws, with consequent variation of an opening of said jaws.

17. The apparatus according to claim 16, wherein said adjustment device comprises a threaded coupling between a terminal end of said tension member and a knob, an initial end of said tension member being integral with a first jaw, said terminal portion being accommodated so that it can slide within a through hole of said second jaw and said knob being screwed onto at least one part of said terminal portion which protrudes with respect to said second jaw.

18. The apparatus according to claim 16, wherein said adjustment device comprises an eccentric rotatable lever coupled to the terminal end of said tension member, the initial end of said tension member being integral with a first jaw, said terminal end passing through a through hole of said second jaw, rotations of said lever modifying a length of a portion of said tension member that is comprised between said jaws.

19. The apparatus according to claim 11, wherein said jaws are constituted by respective mutually opposite pushers, said terminal ends of said jaws being movable from a first arrangement of maximum mutual distance, at which between said jaws there is a distance that is greater than a transverse thickness of the tire, to a second arrangement of minimum mutual distance, at which between them there is a distance that is shorter than the transverse thickness of the tire, with consequent transverse compression of the tire and of content thereof for an easy insertion thereof within a respective receptacle of said rim.

20. The apparatus according to claim 11, further comprising at least one actuator which is controlled by a component chosen between the at least one element for the controlled mutual clamping of said mutually opposite jaws and the at least one rim rotatably engaged in said seat for the controlled rotation of said rim.
